(19) United States
(12) Patent Application Publication
(10) Pub. No.: US 2026/0170292 A1
(43) Pub. Date: Jun. 18, 2026

(54) CLUSTER AND LANGUAGE-BASED FORECASTING FOR NUMERIC TIME SERIES

(71) Applicant: SAP SE, Wolldorf (DE)

(72) Inventors: Mirko Luedde, Nussloch (DE); Stefan Hornet, Bucharest (RO); Viorel Marcu, Bucharest (RO)

(21) Appl. No.: 18/978,843

(22) Filed: Dec. 12, 2024

(51) Int. Cl. G06N 3/042; G06N 3/088

(52) U.S. Cl. CPC G06N 3/042; G06N 3/088

(57) ABSTRACT

In an example embodiment, a large language model (LLM) is utilized to generate a semantic vector for each given time series. These semantic vectors represent additional information generated based on descriptions of the type of the time series (e.g., a description of the material, whose demand over time comprises the time series). The semantic vectors can then be used to stabilize the assignment of clusters in a cluster-based machine learning model, especially for short time series, to improve reliability of predictions.

### TECHNICAL FIELD

This document generally relates to computer systems. More specifically, this document relates to cluster and language-based forecasting for numeric time series.

### BACKGROUND

Time series data refers to a sequence of data points or values that are collected or recorded at successive, equally spaced time intervals. Each data point in a time series is associated with a specific timestamp, and the data typically represents measurements or observations of a phenomenon over time.

Time series modeling refers to the process of using statistical or machine learning techniques to analyze and forecast time-dependent data. The goal is to understand the underlying patterns in the data (such as trends, seasonality, and noise) and use these patterns to predict future values. Time series models take into account the temporal order of data, meaning that the timing of each observation influences its relationship with past and future data points.

### BRIEF DESCRIPTION OF THE DRAWINGS

The present disclosure is illustrated by way of example and not limitation in the figures of the accompanying drawings, in which like references indicate similar elements.

FIG. 1 is a diagram illustrating two clusters of historical data, in accordance with an example embodiment.

FIG. 2 depicts a time series that is forecast using a cluster-based machine learning model, in accordance with an example embodiment.

FIG. 3 is a block diagram illustrating a system for training and using a cluster-based machine learning model, in accordance with an example embodiment.

FIG. 4 is a flow diagram illustrating a method of training a cluster-based machine learning model, in accordance with an example embodiment.

FIG. 5 is a flow diagram illustrating a method for projecting future values of an input time series, in accordance with an example embodiment.

FIG. 6 is a block diagram illustrating a software architecture, in accordance with an example embodiment.

FIG. 7 illustrates a diagrammatic representation of a machine in the form of a computer system within which a set of instructions may be executed for causing the machine to perform any one or more of the methodologies discussed herein.

### DETAILED DESCRIPTION

The description that follows discusses illustrative systems, methods, techniques, instruction sequences, and computing machine program products. In the following description, for purposes of explanation, numerous specific details are set forth to provide an understanding of various example embodiments of the present subject matter. It will be evident, however, to those skilled in the art, that various example embodiments of the present subject matter may be practiced without these specific details.

Accurately predicting future information based on historical time series can be technically challenging. One solution would be to use a cluster-based machine learning model to perform the forecasting. In this approach, historical time series are grouped into clusters based on similar patterns. For example, if one were to attempt to forecast the demand for replacement automotive parts, then historical time series of demand for various parts could be accessed and fed into the cluster-based machine learning model, which essentially learns the patterns on the historical data. Historical time series data of parts could then be clustered into clusters, with each cluster consisting of a set of similar demand time series and representing a joint demand pattern.

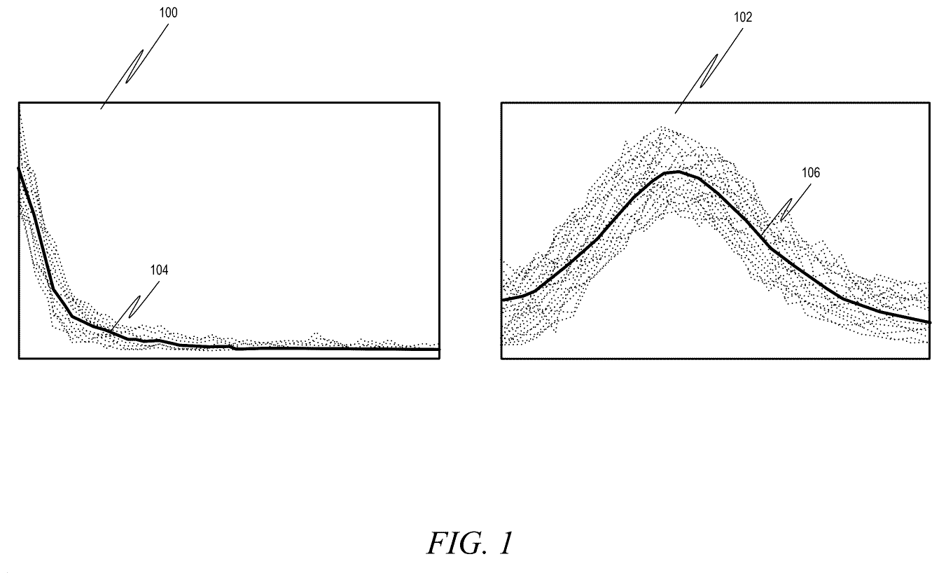

FIG. 1 is a diagram illustrating two clusters of historical data, in accordance with an example embodiment. Here, a first cluster 100 contains time series showing demand according to a first pattern, while second cluster 102 contains time series showing demand according to a second pattern. The first pattern involves high demand at the beginning of the time series which sharply drops over time and then levels out for the remaining of the time series. The second pattern involves low-to-medium demand at the beginning of the time series which steadily rises to a peak and then steadily declines for the remainder of the time series. The center line of each cluster over time represents the trained model, a highly condensed and potentially generalizable view of the historic data. This is represented as center line 104 of the first cluster 100 and the center line 106 of the second cluster 102.

While only two clusters 100, 102 are depicted here, each representing a different time series pattern, one of ordinary skill in the art will recognize that there may be any number of such clusters. In the automotive replacement parts space, for example, there may be hundreds or even thousands of clusters, each representing a different time series pattern.

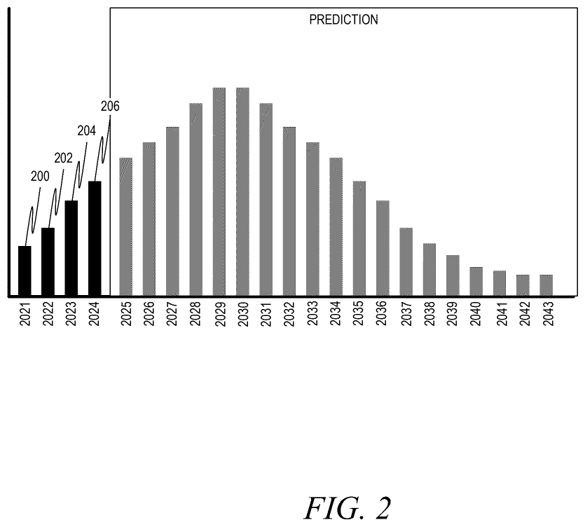

The goal of the cluster-based machine learning model is to learn the patterns and perform the clustering, and then, at prediction time, to match an initial and possibly short time series of a replacement part with unknown future demands to one of the clusters. FIG. 2 depicts a time series that is forecast using a cluster-based machine learning model, in accordance with an example embodiment. Here, data points 200, 202, 204, and 206 are known but future data points are not known. The data points 200, 202, 204, and 206 therefore represent an initial time series of historical data, but it can be matched with the beginning pattern of one of the clusters, here specifically matching the second cluster 102 from FIG. 1. Thus, the future demand curve for the time series in FIG. 2 can be predicted based on the second pattern, from the second cluster 102.

More specifically, such a cluster-based machine learning model could be trained as follows. A set of historic numeric time series X is read from input. Specifically, the numeric value of the time series X at time T is read as X(T). The variable “X” is also used to also denote the corresponding item (e.g. a specific replacement part) to which the time series pertains. “The item X” or “the time series X” can be used to distinguish these cases. Optionally, an assignment of classes to items can be read as a non-negative integer number N_CLS(X). The number N_CLS(X) represents a classification of the item X that may be a relevant additional input to calculating the patterns, independent from the historic time series data of X. For example, one may wish to include the distinction of engine parts from other automative parts, and thus an engine part with a similar demand pattern to a non-engine part may, or may not, be assigned to a different cluster than the non-engine part, depending on the discretion of the clustering algorithm.

The count of the number of classes may be represented as N_CLASSES. A non-negative number R_WGT, called a “semantic weight”, is input as parameter, which represents the relative importance of the classification data compared to the time series data. In some embodiments, a sequence of such weights, which provides one weight for each bin, wherein a bin is an abstraction of a storage area for a grouping of vectors. A parameter N_LEN_FC_MODEL is input, which represents the desired length of the forecast (e.g., the number of future time steps) that shall be supported by the model in each single forecast iteration step. Another parameter N_CLUSTERS, which is the desired number of clusters per bin, is read from input. After training, each bin holds a set of up to N_CLUSTERS many clusters. A function R_NRM is determined by the input (e.g., in one embodiment, this function is selected from a set of predefined functions by means of some input parameter). This function maps any numeric time series X to some non-negative number R_NRM(X), which will be called the “norm” of X. The function R_NRM shall be a mathematical norm function. E.g. the function R_NRM can be chosen as the l1 norm function (also called the Manhattan norm function), which maps any time series X to the sum of the absolute values of the quantities X(T) over all indexes T. E.g. the function R_NRM can be chosen as the l2 norm function (also called the Euclidean norm function), which maps any time series X to the square root of the sum of the quantities (X(T)*X(T)) over all indexes T. E.g. the function R_NRM can be chosen such that R_NRM(X) is equal to the absolute value of the number X(T), where T is the largest index at which the time series X is non-zero, if any such index exists, else R_NRM(X) is equal to zero.

Before training, each bin holds a set of vectors, all of which have the same dimensionality, which is determined by this bin. Each such vector is constructed from the time series of some input item X and optionally from the classification number N_CLS(X) of this item X according to some preprocessing procedure. After training, each bin holds a set of clusters, each of which is a set of vectors. Some embodiments may rather use the cluster center vectors (as opposed to the full clusters) and, optionally, further information (e.g. the radius of the cluster, or the radius of a sphere around the cluster center containing eighty percent of the vectors of this cluster).

Items, whose time series are trivial can be dropped, as those account for parts having no demand at all over time.

If classifications are provided, then for each input item X, an indicator vector V_IDC(X) is constructed (also known as a one-hot encoding). The index I for the coordinates of the vector V_IDC(X) ranges from one to N_CLASSES. If N_CLS(X) is equal to I (that is, the class with index I is assigned to the item X), then the value of V_IDC(X) at this index I is equal to one. If N_CLS(X) is not equal to the index I, then the value of V_IDC(X) at this index I is equal to zero.

For each item X retained, the leading zeroes of its time series are stripped, thereby retaining only the tail vector V_TAIL(X) of the time series. Thereby, the time index is re-indexed such that the first non-zero value of V_TAIL(X) occurs at the time index T equal to one, while the maximum value of the time index T equals the length N_LEN(V_TAIL(X)) of the tail V_TAIL(X) of the time series of X. The lengths of V_TAIL(X) may vary for varying X, even if initially all time series X would have the same length.

Either a prefix model or a suffix model can be used. Either of these kinds of models has a certain advantage for forecasting, depending on the data to which it is applied. While prefix models emphasize the beginning (the “prefix”) of each time series used for training, suffix models emphasize the end of the time series (the “suffix”). For a prefix model, let N_MAX_BIN be equal to the maximum of the numbers N_LEN(V_TAIL(X)) over all the time series X retained. For every number N_BIN (this is the index of some bin) ranging from one up to N_MAX_BIN, the set of the items X for which N_BIN is less than or equal to N_LEN(V_TAIL(X)) are retained. For each X retained, the vector V_PFX(V_TAIL(X)) is calculated as the projection of the tail vector V_TAIL(X) to its first N_BIN coordinates, that is, to its prefix of length N_BIN (the projection of some vector V of dimensionality N to its prefix of length M is equal to the unique vector U of dimensionality M, such that the value of U at the index T is equal to the value of V at this index T, for all indexes T from one up to M). For completeness, one could rather write V_PFX(V_TAIL(X), N_BIN) to indicate the dependence on N_BIN, but for readability, it is omitted from notation.

A clustering of the vectors ((V_PFX(V_TAIL(X))/R_NRM(V_PFX(V_TAIL(X))))++(V_IDC(X)*R_WGT)) is then calculated, where X ranges over the items retained for the current bin N_BIN, where the mark ‘++’ denotes the direct sum of vectors (the direct sum of some vector V of dimensionality M with some vector W of dimensionality N is equal to the unique vector U (which is written as V++W) of dimensionality M plus N, for which the value of U at the index T is equal to the value of V at T, if T is greater than zero and less than or equal to M, and the value of U at T is equal to the value of W at T, if T is greater than M and less than or equal to M plus N), and where R_WGT (which may depend on N_BIN) is the semantic weight read from input, into up to N_CLUSTERS many clusters. The number R_NRM(V_PFX(V_TAIL(X))) is non-zero, since the prefix of the tail of the time series of X starts with a non-zero value and R_NRM is a mathematical norm function.

For a suffix model, again let N_MAX_BIN be equal to the maximum of N_LEN(V_TAIL(X)) over all items X. For every number N_BIN ranging from one up to N_MAX_BIN, the set of items X for which N_BIN is less or equal to N_LEN(V_TAIL(X)) are retained. For each X retained, the vector V_SFX(V_TAIL(X)) is calculated as the projection of V_TAIL(X) to its last N_BIN coordinates, that is, to its suffix of length N_BIN (the projection of some vector V of dimensionality N to its suffix of length M is equal to the unique vector U of dimensionality M, for which the value of U at the index T is equal to the value of V at the index N minus M plus T, for all indexes T from one up to M). For completeness, V_SFX(V_TAIL(X), N_BIN) is written to indicate the dependence on N_BIN, but for readability, it is omitted from the notation. If the vector V_SFX(V_TAIL(X)) is equal to the zero vector (that is, the last N_BIN coordinates of V_TAIL(X) are equal to zero), then the item X is discarded from the current bin with index N_BIN.

A clustering of the vectors ((V_SFX(V_TAIL(X))/R_NRM(V_SFX(V_TAIL(X)))++(V_IDC(X)*R_WGT))) is then calculated, where X ranges over the items retained for the current bin N_BIN, where the mark ‘++’ denotes the direct sum of vectors, and where R_WGT is the semantic weight (which may depend on N_BIN) read from input, into N_CLUSTERS many clusters.

For suffix models, R_NRM(V_SFX(V_TAIL(X))) is a non-zero number for each item X retained in the current bin, since X would have been discarded otherwise from the current bin (in which case X may still be retained for some other bin).

For every number N_BIN (the index of some bin) ranging from one up to N_MAX_BIN and for every number N_CLST (the index of some cluster) ranging from one up to N_CLUSTERS, let V_CENT(N_CLST, N_BIN) be the center vector of the cluster with index N_CLST of the bin with index N_BIN. This vector has dimensionality (N_BIN+N_CLASSES). The first N_BIN coordinates of this vector are the time coordinates, while the last N_CLASSES coordinates are the classification coordinates. The projection of the vector to its time coordinates (this is the projection to its prefix of length N_BIN) can be referred to as the “time part” of the vector.

The cluster center vectors V_CENT(N_CLST, N_BIN) for all N_BIN and N_CLST are then output. Some embodiments may rather use the full clusters (as opposed to their cluster center vectors) and, optionally, further information (e.g. the radius of the cluster, or the radius of a sphere around the cluster center containing eighty percent of the vectors of this cluster). There are up to N_MAX_BIN times N_CLUSTERS many such clusters and, thus, cluster center vectors. There may be fewer than this maximal number of center vectors, if in some instances fewer than N_CLUSTERS many clusters have been obtained. This output represents the trained cluster-based machine learning model. In some embodiments, only those center vectors will be retained for the model, for which N_BIN is greater than the input parameter N_LEN_FC_MODEL. This may improve memory usage for those cases, where at the time of training the model, the user anticipates that the model shall be used to forecast at least N_LEN_FC_MODEL future points in time, for every forecast. The forecast procedure itself is described further below when introducing forecasting component 318.

Using the trained models obtained by the above approach (prefix models or suffix models, with or without including classification data) for forecasting, however, can still be problematic in some instances. Specifically, it relies on use of past information of time series, but it does not factor in the possibility that some time series, which initially are similar to each other, can become dissimilar in the future based on some other factor than merely patterns of their historical demand observed so far. This holds even when including a user-defined classification to generate dissimilarity between items, whose historical time series may be similar or equal. This can create inaccuracies in predictions for time series with little historical information (e.g., in an extreme case, an automotive part with only a single historical data point, such as a single year of demand information) or ones that do not easily or accurately fit into any user-defined class.

More specifically, the shorter the initial piece of a time series to be forecasted is, the greater the uncertainty of the resulting forecast. For short historic time series, small and perhaps irrelevant details of the time series may govern the choice of the assigned cluster. This may lead to grossly different forecasts depending on irrelevant details.

In an example embodiment, a large language model (LLM) is utilized to generate semantic vectors for any given item, of which a description in human language is available. These semantic vectors represent additional information generated, based on descriptions of the type of the item (e.g., a description of the replacement part whose demand forms the time series). The semantic vectors can then be used to improve the determination of clusters from items and their time series, and the assignment of items and time series to clusters, especially for short time series.

A large language model (LLM) refers to an artificial intelligence (AI) system that has been trained on an extensive dataset to understand and generate human language. These models are designed to process and comprehend natural language in a way that allows them to answer questions, engage in conversations, generate text, and perform various language-related tasks.

As part of their processing, LLMs generate embeddings based on input. Essentially, the embeddings are a numerical representation of the semantic “meaning” of the input. An embedding is a mathematical representation of data as a vector in a N-dimensional space. In the N-dimensional space, distance and angle (usually and misleadingly called “cosine distance”) between any two vectors can be defined and it is possible to determine that two vectors are close to each other geometrically, or that they are distant from each other. Essentially, the closer the coordinates of one vector are to the coordinates of another vector, the closer these vectors are to each other in the N-dimensional space. Thus, calculating distance or angle between vectors allows context-based search and text extraction to be performed on the human language texts underlying the vectors.

Here, the embeddings generated by the LLM are used as semantic vectors to improve the training and forecasting by a cluster-based machine learning model.

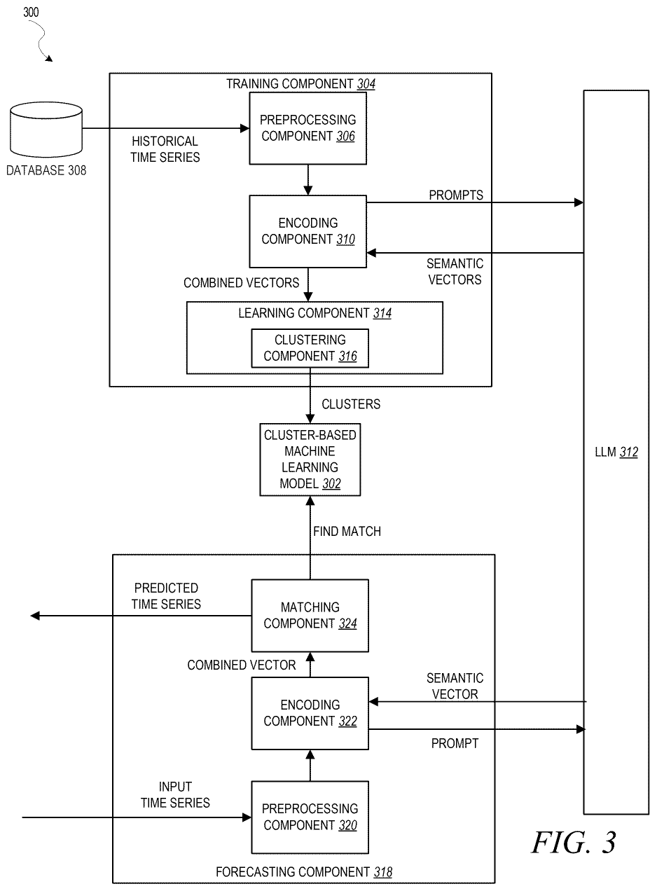

FIG. 3 is a block diagram illustrating a system 300 for training and using a cluster-based machine learning model 302, in accordance with an example embodiment. A training component 304 acts to train the cluster-based machine learning model 302. Specifically, a preprocessing component 306 reads a set of time series, such as by obtaining them from a database 308. The database 308 may be any type of database, but in some example embodiments it is an in-memory database. One example of an in-memory database is HANA™, from SAP SE of Walldorf, Germany. An in-memory database (also known as an in-memory database management system) is a type of database management system that primarily relies on main memory for computer data storage. It is contrasted with database management systems that employ a disk storage mechanism. In-memory databases are faster than traditional disk storage databases because disk access is slower than memory access.

Regardless of the type of database 308, the set of time series is either directly read from the database 308 or computed based on data from the database 308. In the latter case, for example, a material successor graph could be read from the database 308, reachability weights computed from the material successor graph, and time series combined based on these weights. In this context, “material” is used to indicate a type of a product or part. The material could be, for example, a raw material (e.g., steel), or a finished material (e.g., a carburetor). While the term “material” is used in this explanation, the same techniques could be applied to anything that the time series pertains to. For example, rather than forecasting demand for automotive parts, a model may be developed to forecast demand for processing time in a computer system. In such a case, the time series may pertain to different services or applications rather than different physical components, but the same modeling techniques as described herein could apply.

The preprocessing component 306 then can calculate the tails of the time series, such as by cutting off the beginning of time series that contain no data or have only zero value data.

An encoding component 310 then acts to cause the generation of a semantic vector for each time series. In this case, the encoding component 310 may obtain a set of natural language (e.g., English) descriptions for the time series from the database 308. Each time series may have such a description for whatever the time series pertains. Thus, if the time series is for demand for a carburetor, then the description may be a description of the carburetor. This could include generic information (e.g., what a carburetor is and what it does) or specific information (e.g., unique properties of this particular carburetor).

The encoding component 310 then, for each item X to which a time series pertains, determines a semantic vector V_SMV(X) from the description of X. This is achieved, in one embodiment, by directly executing functionality of the LLM 312. Another embodiment may form a prompt using the corresponding natural language description and may send this prompt to an LLM 312.

It should be noted that the term “prompt” as used herein shall be interpreted broadly to encompass both a traditional LLM prompt, where a text-based input is generated and sent over a network to a remote LLM, as well as a non-traditional LLM prompt, such as where a method call is generated to a locally running process that operates the LLM. In the latter case, the method call itself shall be considered to be a prompt.

LLMs used to generate information are generally referred to as Generative Artificial Intelligence (Gen AI) models. A Gen AI model may be implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance.

The bidirectional encoder may be implemented as a Bidirectional Long Short-Term Memory (BiLSTM) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs comprise a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer to language modeling. This contrasts with prior art solutions that looked at a text sequence either from left to right or combined left to right and right to left. A bidirectionally trained language model has a deeper sense of language context and flow than single-direction language models.

More specifically, the transformer encoder reads the entire sequence of information, and thus is considered to be bidirectional (or, alternatively, non-directional). This characteristic allows the model to learn the context of a piece of information based on all its surroundings.

In other example embodiments, a generative adversarial network (GAN) embodiment may be used. GAN is a supervised machine learning model that has two sub-models: a generator model that is trained to generate new examples, and a discriminator model that tries to classify examples as either real or generated. The two models are trained together in an adversarial manner (using a zero-sum game according to game theory) until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, though a clever property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a Variational AutoEncoders (VAEs) model. VAEs comprise an encoder network that compresses the input data into a lower-dimensional representation, called alatent code, and a decoder network that generates new data from the latent code. In either case, the GAI model contains a generative classifier, which can be implemented as, for example, a naïve Bayes classifier.

When a GAI model, which uses an LLM, generates new, original data, it goes through the process of evaluating and classifying the data input to it. The product of this evaluation and classification is utilized to generate embeddings for data, which can then be later used to generate new data by the GAI model. In an example embodiment, however, the new data is either not generated or is irrelevant to the present solution. Rather, an embedding for the input piece of text is generated based on the intermediate work product of the GAI model that it would produce when going through the motions of generating the new, original data.

The result of an embedding process performed on a piece of data is an embedding, which is a vector. In this case, it is called a semantic vector because it may be generated based on a textual human language description and encodes the semantic meaning of the description.

Thus, referring to FIG. 3, the semantic vectors V_SMV(X) are sent back from the LLM 312 to the encoding component 310. Thereby, the dimensionality of the vectors V_SMV(X) is determined by the LLM 312 and is independent of X.

It should be noted that while the LLM 312 is depicted here as being separate from the encoding component 310, in some example embodiments it may be located within the encoding component 310 itself, or at least on the same computer or computing system as the encoding component 310 (e.g., “locally”). Additionally, there is no requirement that the LLM 312 be a general-purpose LLM. It could be, for example, a fine-tuned LLM, which is essentially a general-purpose LLM that has been fine-tuned with domain specific knowledge to become a domain-specific LLM. Thus, for example, an LLM may be specially trained using language commonly used in the automotive industry to become an automotive-specific LLM.

A learning component 314 then takes each pair of time series tail V_TAIL(X) and semantic vector V_SMV(X) and attempts to cluster their combination into clusters. This is different than, for example, merely clustering the time series tails themselves, or clustering a combination of time series tails and user-supplied classes.

This clustering proceeds in a similar way as described as steps (0020) to (0029). However, the indicator vectors V_IDC(X) which are used there, are replaced by the semantic vectors V_SMV(X) here. In some embodiments, the semantic vectors can be used in addition to the indicator vectors. More specifically, for each index N_BIN from one to N_MAX_BIN, where N_MAX_BIN is the maximum length of any tail, each tail of length at least N_BIN is projected to its prefix V_PFX(V_TAIL(X)) (or to its suffix V_SFX(V_TAIL(X))) of length N_BIN. Weighted direct sums of these prefixes or suffixes, normalized by some norm function, as explained above, with the corresponding semantic vectors, are calculated as ((V_PFX(V_TAIL(X))/R_NRM(V_PFX(V_TAIL(X))))++(V_SMV(X)*R_WGT)) for prefix models, respectively as ((V_SFX(V_TAIL(X))/R_NRM(V_SFX(V_TAIL(X))))++(V_SMV(X)*R_WGT)) for suffix models, where X ranges over the time series retained for the current bin N_BIN, where the mark ‘++’ denotes the direct sum of vectors, and where R_WGT is the semantic weight read from input. Next, these vectors are clustered into N_CLUSTERS many clusters. The cluster centers V_CENT(N_CLST, N_BIN), of which there are up to N_MAX_BIN times N_CLUSTERS many, are then output by the learning component 314, essentially forming the trained cluster-based machine learning model 302. The clustering operation itself may be performed by a clustering component 316, which performs a clustering algorithm. Specifically, the number N_CLUSTERS of clusters is read as well as the set of direct sum vectors as calculated above. In an example embodiment, a K-means algorithm is used with the Manhattan distance (l1 distance). Optionally, the time parts of the cluster centers V_CENT(N_CLST, N_BIN) are smoothed by a standard smoothing algorithm (such as moving average smoothing using the mean or the median of the values over a small interval of time indexes) before being provided back.

The Manhattan distance (l1 distance) between two points is the sum of the absolute differences of their coordinates, rather than the square root of the sum of squared differences as in Euclidean distance (l2 distance).

K-means clustering with Manhattan distance works by randomly selecting K vectors, which are the initial centroids, from the dataset. Then, for each data point, the algorithm computes the Manhattan distance (l1 distance) to each of the centroids and assigns the point to the cluster whose centroid is closest (i.e., has the smallest Manhattan distance). After assigning points to clusters, each centroid is replaced by the mean of the points within its cluster.

The algorithm repeats this process of assigning points to clusters and updating centroids until the centroids stabilize (that is, their changes become sufficiently small) or a set number of iterations is reached.

It should be noted that K-means using Manhattan distance is only one possible clustering algorithm that would work for purposes of this disclosure, and nothing in this disclosure shall be taken as limiting the scope of protection to only K-means using Manhattan distance unless expressly claimed.

Once trained, the cluster-based machine learning model 302 may then be used to forecast future values for time series, specifically for time series having short lengths. Specifically, this forecasting is performed by a forecasting component 318. The forecasting component 318 may contain some similar submodules as the training component 304. These submodules could be shared between the training component 304 and the forecasting component 318, or alternatively different copies of the submodules may be present in the training component 304 and forecasting component 318. Here, they will be depicted as different copies.

Thus, an input item X is received by the forecasting component 318. The time series of X may be short, and the desire is to predict the future data points in this time series. Also, the desired length of the forecast (that is, the number of future data points to be predicted) is input as a parameter N_LEN_FC, and a norm function R_NRM_FC is input (e.g. by selecting from a predefined set of possible norm functions). A preprocessing component 320 performs similar functionality as preprocessing component 306 in that it reads the input time series and calculates the tail V_TAIL(X) of the time series, outputting this tail.

An encoding component 322 performs similar functionality of encoding component 310 in that it reads a natural language description pertaining to the input item X and causes generation of a semantic vector V_SMV(X) for X, such as by using the LLM 312.

In some example embodiments, the encoding component 322 may be the same component as encoding component 310, such that the encoding component is shared among multiple processes.

A matching component 324 then attempts to match the input time series tail and its corresponding semantic vector with a cluster in the trained cluster-based machine learning model 302. Specifically, let N_LEN(V_TAIL(X)) be the tail length. Let N_LEN_FC_MODEL be the forecast length which was used when creating the trained model. Let N_BIN be equal to (N_LEN(V_TAIL(X))+N_LEN_FC_MODEL). It may occur that N_BIN is larger than N_MAX_BIN. This will occur if the tail of the input time series X is sufficiently long. In this case, a prefix model does not produce any useful forecast for X. However, for suffix models, a sufficiently short suffix of V_TAIL(X) is used in place of V_TAIL(X), such that N_BIN obtained as above is less than or equal to N_MAX_BIN. As per construction, each center vector V_CENT(N_CLST, N_BIN) is equal to the direct sum of its time part plus its semantic part. That is, V_CENT(N_CLST, N_BIN) equals (V_CENT_TIM(N_CLST, N_BIN)++V_CENT_SMV(N_CLST, N_BIN)), where V_CENT_TIM(N_CLST, N_BIN) is a vector of dimensionality N_BIN and V_CENT_SMV(N_CLST, N_BIN) is a vector of some dimensionality determined by the LLM 312. The time parts of the center vectors are projected to their first N_LEN(V_TAIL(X)) coordinates and normalized. That is, from each vector V_CENT_TIM(N_CLST, N_BIN) one can obtain a vector (V_CENT_PAST(N_CLST, N_BIN)/R_NRM(V_CENT_PAST(N_CLST, N_BIN))), where V_CENT_PAST(N_CLST, N_BIN) is the vector obtained from projecting to the first N_LEN(V_TAIL(X)) coordinates and R_NRM is the norm function used by the trained model. Next, the cluster index N_CLST is determined such that the vector (V_CENT_PAST(N_CLST, N_BIN)/R_NRM(V_CENT_PAST(N_CLST, N_BIN))++V_CENT_SMV(N_CLST, N_BIN)) obtained from this cluster is closest to the vector (V_TAIL(X)/R_NRM(V_TAIL(X))++R_WGT*V_SMV(X)), where R_WGT is the semantic weight as used by the trained model. Next, a forecast of length N_LEN_FC_MODEL is determined as the projection of the vector V_CENT_TIM(N_CLST, N_BIN) to its last N_LEN_FC_MODEL coordinates, multiplied by the factor R_NRM_FC(V_TAIL(X))/R_NRM_FC(V_CENT_PAST(N_CLST, N_BIN)), where R_NRM_FC is the norm function input to (or configured for) the forecasting component 318. If N_LEN_FC_MODEL is less than N_LEN_FC, then this procedure is iterated until a forecast of the desired length N_LEN_FC is obtained. Thereby, each iterative step adds N_LEN_FC_MODEL future data points to the time series to be forecasted.

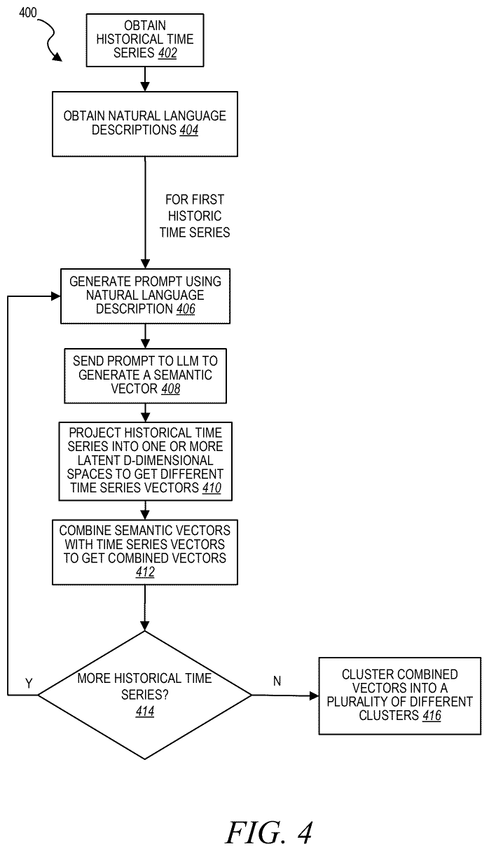

FIG. 4 is a flow diagram illustrating a method 400 of training a cluster-based machine learning model, in accordance with an example embodiment. At operation 402, a plurality of different historical time series are obtained from a database. Each historical time series represents a series of values over time, corresponding to a particular item, such as a part or resource. The values could represent, for example, demand. At operation 404, a natural language description pertaining to each of the historical time series is obtained. Each natural language description may be, for example, a description of the corresponding item to which the time series pertains.

A loop then begins for each of the different historical time series in the plurality of historical time series. At operation 406, a prompt is generated for the corresponding historical time series based on the natural language description. In an example embodiment, the prompt includes the natural language description. At operation 408, the prompt is sent to an LLM to generate a semantic vector corresponding to the historical time series. The semantic vector is a sequence of numbers constituting an embedding of semantic meaning of natural language text, in a N-dimensional space, where the number N is prescribed by the LLM.

At operation 410, the corresponding historical time series is projected into one or more time series vectors in different D-dimensional spaces, for each D ranging from one plus N_LEN_FC_MODEL up to the length of the tail of the time series. These projections may be performed using either the prescription to obtain a prefix model, or to obtain a suffix model.

At operation 412, for each D-dimensional space, the semantic vector in the N-dimensional space and the corresponding time series vector in the D-dimensional space are combined (e.g. by using a direct sum, as explained above) into a combined vector (e.g. of dimensionality D plus N), for each D as above.

At operation 414, it is determined if there are any more historical time series in the plurality of historical time series. If so, then the method 400 loops back to operation 406 for the next historical time series in the plurality of historical time series.

If not, then at operation 416, the combined vectors are clustered into a plurality of different clusters, obtaining such a plurality separately for each dimension D as above. Each cluster has a center vector, which may represent the average vector of the combined vectors in the cluster. Such an average vector may be conceived of as a line in a line chart, where the line represents the average of all lines, representing the combined vectors in the cluster. It should be noted that, unlike a traditional line representation of values of a time series, this combined vector is not merely indicative of the values of the time series, but a representation of the combination of the values of the time series and the semantic meaning of the corresponding natural language description, if both were projected into the M-dimensional space, where M is equal to the sum of D as above plus the dimensionality N determined by the LLM 312.

The resulting clusters, and their corresponding center vectors, represent the trained cluster-based machine learning model.

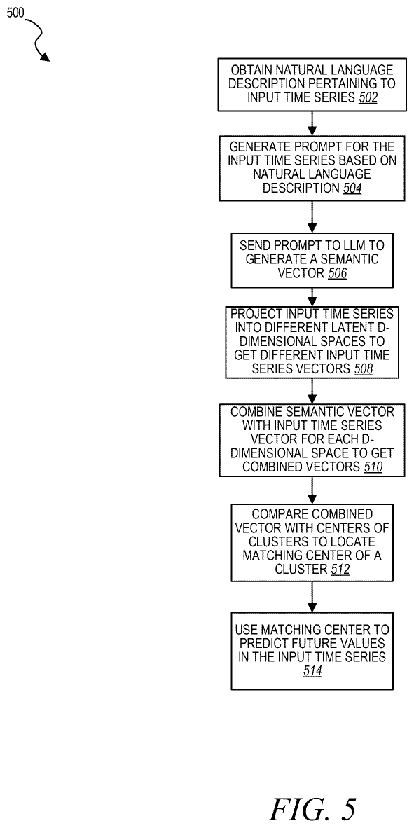

FIG. 5 is a flow diagram illustrating a method 500 for predicting future values of an input time series, in accordance with an example embodiment. At operation 502, a natural language description pertaining to the input time series is obtained. This may be, for example, a description of the corresponding item to which the input time series pertains.

At operation 504, a prompt is generated for the input time series based on the natural language description. In an example embodiment, the prompt includes the natural language description. At operation 506, the prompt is sent to an LLM to generate a semantic vector corresponding to the input time series. The semantic vector is a sequence of numbers constituting an embedding of semantic meaning of natural language text, in the N-dimensional space.

At operation 508, the input time series is projected into a time series vector in the D-dimensional space. This may be performed using either a prefix model or a suffix model.

At operation 510, for each D-dimensional space, the semantic vector in the N-dimensional space and the corresponding time series vector in the D-dimensional space are combined (e.g. by using a direct sum, as explained above) into a combined vector (e.g. of dimensionality D plus N).

At operation 512, the combined vector is compared with center vectors of clusters representing the trained cluster-based machine learning model, to locate a matching center of a cluster. At operation 514, the matching center vector is used to predict future values in the input time series.

In view of the disclosure above, various examples are set forth below. It should be noted that one or more features of an example, taken in isolation or combination, should be considered within the disclosure of this application.

Example 1 is a system comprising: at least one hardware processor; a non-transitory computer-readable medium storing instructions that, when executed by the at least one hardware processor, cause the at least one hardware processor to perform operations comprising: for each of a plurality of historical time series: generating a prompt based on a natural language description pertaining to a corresponding historical time series; sending the prompt to a large language model (LLM) to generate a semantic vector for the corresponding historical time series, each semantic vector being a sequence of numbers constituting an embedding of semantic meaning of natural language text in a N-dimensional space; projecting the corresponding historical time series into one or more time series vectors, each time series vector existing in a different D-dimensional space; combining, for each different D-dimensional space, the corresponding semantic vector and the corresponding time series vector into a combined vector; clustering the combined vectors into a plurality of different clusters; and predicting future data values in an input time series by matching a combined vector corresponding to the input time series to a center vector of one of the plurality of different clusters.

In Example 2, the subject matter of Example 1, wherein the predicting comprises: generating an input time series prompt based on a natural language description pertaining to the input time series; sending the input time series prompt to the LLM to generate a semantic vector for the input time series; projecting the input time series into an input time series vector in the D-dimensional space; combing the semantic vector for the input time series with the input time series vector into a combined input time series vector; and wherein the matching comprises matching the combined input time series vector to the center of the one of the plurality of different clusters.

In Example 3, the subject matter of Examples 1-2 includes, wherein each D-dimensional space has a different semantic weight, the semantic weight being applied to the semantic vector prior to the combining.

In Example 4, the subject matter of Examples 1-3 includes, wherein the clustering uses a K-means clustering algorithm.

In Example 5, the subject matter of Examples 1-4 includes, wherein the clustering additionally uses and the predicting on use a suffix model.

In Example 6, the subject matter of Examples 4-5 includes, wherein the K-means clustering algorithm is performed using Manhattan distance.

In Example 7, the subject matter of Examples 1-6 includes, wherein each time series indicates demand of an item over time.

In Example 8, the subject matter of Example 7 includes, wherein the natural language description is a description of the item.

In Example 9, the subject matter of Examples 1-8 includes, wherein the time series are stored in an in-memory database.

Example 10 is a method comprising: for each of a plurality of historical time series: generating a prompt based on a natural language description pertaining to a corresponding historical time series; sending the prompt to a large language model (LLM) to generate a semantic vector for the corresponding historical time series, each semantic vector being a sequence of numbers constituting an embedding of semantic meaning of natural language text in a different DN-dimensional space; projecting the corresponding historical time series into one or more time series vectors, each time series vector existing in a different D-dimensional space; combining, for each different D-dimensional space, the corresponding semantic vector and the corresponding time series vector into a combined vector; clustering the combined vectors into a plurality of different clusters; and predicting future data values in an input time series by matching a combined vector corresponding to the input time series to a center vector of one of the plurality of different clusters.

In Example 11, the subject matter of Example 10 includes, wherein the projecting comprises: generating an input time series prompt based on a natural language description pertaining to the input time series; sending the input time series prompt to the LLM to generate a semantic vector for the input time series; projecting the input time series into an input time series vector in the D-dimensional space; combing the semantic vector for the input time series with the input time series vector into a combined input time series vector; and wherein the matching comprises matching the combined input time series vector to the center of the one of the plurality of different clusters.

In Example 12, the subject matter of Examples 10-11 includes, wherein the clustering uses a K-means clustering algorithm.

In Example 13, the subject matter of Example 12 includes, wherein the K-means clustering algorithm is performed using Manhattan distance.

In Example 14, the subject matter of Examples 10-13 includes, wherein each time series indicates demand of an item over time.

In Example 15, the subject matter of Example 14 includes, wherein the natural language description is a description of the item.

In Example 16, the subject matter of Examples 10-15 includes, wherein the time series are stored in an in-memory database.

Example 17 is a non-transitory machine-readable medium storing instructions which, when executed by one or more processors, cause the one or more processors to perform operations comprising: for each of a plurality of historical time series: generating a prompt based on a natural language description pertaining to a corresponding historical time series; sending the prompt to a large language model (LLM) to generate a semantic vector for the corresponding historical time series, each semantic vector being a sequence of numbers constituting an embedding of semantic meaning of natural language text in a different DN-dimensional space; projecting the corresponding historical time series into one or more time series vectors, each time series vector existing in a different D-dimensional space; combining, for each different D-dimensional space, the corresponding semantic vector and the corresponding time series vector into a combined vector; clustering the combined vectors into a plurality of different clusters; and predicting future data values in an input time series by matching a combined vector corresponding to the input time series to a center vector of one of the plurality of different clusters.

In Example 18, the subject matter of Example 17 includes, wherein the projecting comprises: generating an input time series prompt based on a natural language description pertaining to the input time series; sending the input time series prompt to the LLM to generate a semantic vector for the input time series; projecting the input time series into an input time series vector in the D-dimensional space; combing the semantic vector for the input time series with the input time series vector into a combined input time series vector; and wherein the matching comprises matching the combined input time series vector to the center of the one of the plurality of different clusters.

In Example 19, the subject matter of Examples 17-18 includes, wherein each D-dimensional space has a different semantic weight, the semantic weight being applied to the semantic vector prior to the combining.

In Example 20, the subject matter of Examples 17-19 includes, wherein the clustering uses a K-means clustering algorithm.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

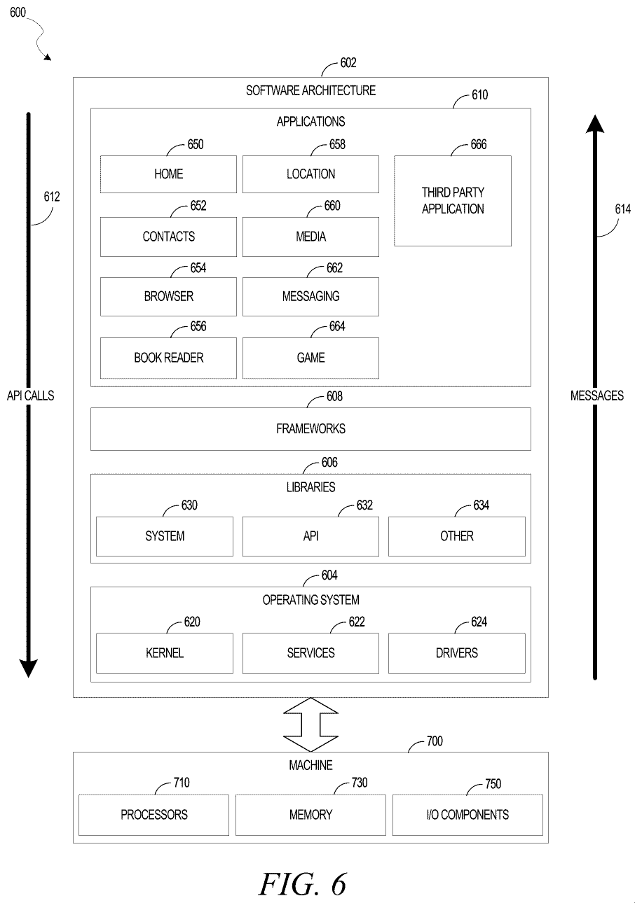

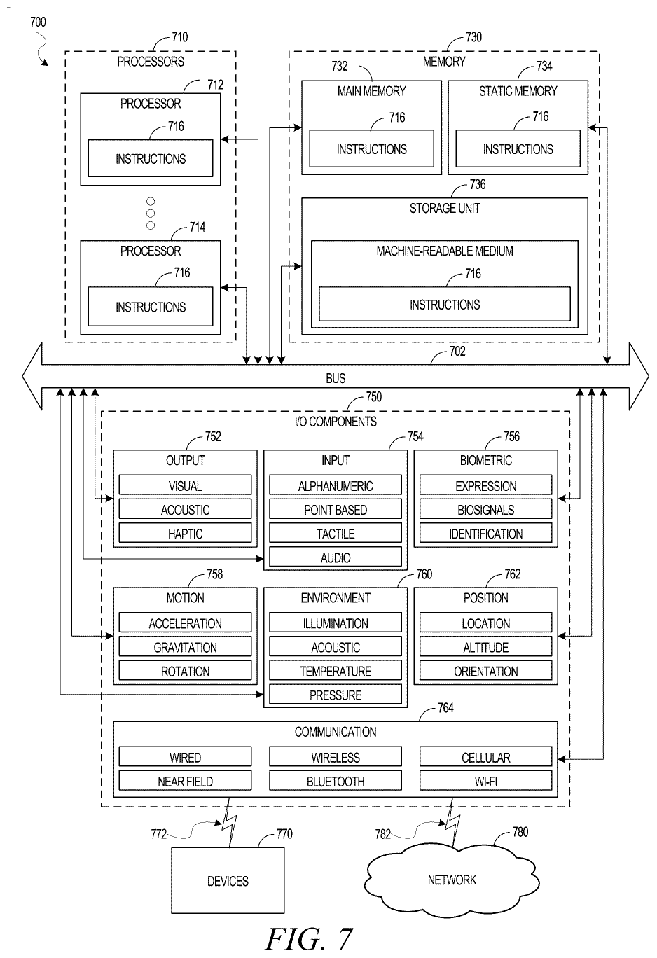

FIG. 6 is a block diagram 600 illustrating a software architecture 602, which can be installed on any one or more of the devices described above. FIG. 6 is merely a non-limiting example of a software architecture, and it will be appreciated that many other architectures can be implemented to facilitate the functionality described herein. In various embodiments, the software architecture 602 is implemented by hardware such as a machine 700 of FIG. 7 that comprises processors 710, memory 730, and input/output (I/O) components 750. In this example architecture, the software architecture 602 can be conceptualized as a stack of layers where each layer may provide a particular functionality. For example, the software architecture 602 comprises layers such as an operating system 604, libraries 606, frameworks 608, and applications 610. Operationally, the applications 610 invoke API calls 612 through the software stack and receive messages 614 in response to the API calls 612, consistent with some embodiments.

In various implementations, the operating system 604 manages hardware resources and provides common services. The operating system 604 comprises, for example, a kernel 620, services 622, and drivers 624. The kernel 620 acts as an abstraction layer between the hardware and the other software layers, consistent with some embodiments. For example, the kernel 620 provides memory management, processor management (e.g., scheduling), component management, networking, and security settings, among other functionalities. The services 622 can provide other common services for the other software layers. The drivers 624 are responsible for controlling or interfacing with the underlying hardware, according to some embodiments. For instance, the drivers 624 can comprise display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 606 provide a low-level common infrastructure utilized by the applications 610. The libraries 606 can comprise system libraries 630 (e.g., C standard library) that can provide functions such as memory allocation functions, string manipulation functions, mathematic functions, and the like. In addition, the libraries 606 can comprise API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 606 can also comprise a wide variety of other libraries 634 to provide many other APIs to the applications 610.

The frameworks 608 provide a high-level common infrastructure that can be utilized by the applications 610, according to some embodiments. For example, the frameworks 608 provide various GUI functions, high-level resource management, high-level location services, and so forth. The frameworks 608 can provide a broad spectrum of other APIs that can be utilized by the applications 610, some of which may be specific to a particular operating system 604 or platform.

In an example embodiment, the applications 610 comprise a home application 650, a contacts application 652, a browser application 654, a book reader application 656, a location application 658, a media application 660, a messaging application 662, a game application 664, and a broad assortment of other applications, such as a third-party application 666. According to some embodiments, the applications 610 are programs that execute functions defined in the programs. Various programming languages can be employed to create one or more of the applications 610, structured in a variety of manners, such as object-oriented programming languages (e.g., Objective-C, Java, or C++) or procedural programming languages (e.g., C or assembly language). In a specific example, the third-party application 666 (e.g., an application developed using the ANDROID™ or IOS™ software development kit (SDK) by an entity other than the vendor of the platform) may be mobile software running on a mobile operating system such as IOS™, ANDROID™, WINDOWS® Phone, or another mobile operating system. In this example, the third-party application 666 can invoke the API calls 612 provided by the operating system 604 to facilitate functionality described herein.

FIG. 7 illustrates a diagrammatic representation of a machine 700 in the form of a computer system within which a set of instructions may be executed for causing the machine 700 to perform any one or more of the methodologies discussed herein, according to an example embodiment. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example, the instructions 716 may cause the machine 700 to execute the methods 400 and 500 of FIGS. 4 and 5. Additionally, or alternatively, the instructions 716 may implement FIGS. 1-5 and so forth. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specifies actions to be taken by the machine 700. Further, while only a single machine 700 is illustrated, the term “machine” shall also be taken to comprise a collection of machines 700 that individually or jointly execute the instructions 716 to perform any one or more of the methodologies discussed herein.

The machine 700 may comprise processors 710, memory 730, and I/O components 750, which may be configured to communicate with each other such as via a bus 702. In an example embodiment, the processors 710 (e.g., a central processing unit (CPU), a reduced instruction set computing (RISC) processor, a complex instruction set computing (CISC) processor, a graphics processing unit (GPU), a digital signal processor ((SP), an application-specific integrated circuit (ASIC), a radio-frequency integrated circuit (RFIC), another processor, or any suitable combination thereof) may comprise, for example, a processor 712 and a processor 714 that may execute the instructions 716. The term “processor” is intended to comprise multi-core processors that may comprise two or more independent processors (sometimes referred to as “cores”) that may execute instructions 716 contemporaneously. Although FIG. 7 shows multiple processors 710, the machine 700 may comprise a single processor 712 with a single core, a single processor 712 with multiple cores (e.g., a multi-core processor 712), multiple processors 712, 714 with a single core, multiple processors 712, 714 with multiple cores, or any combination thereof.

The memory 730 may comprise a main memory 732, a static memory 734, and a storage unit 736, each accessible to the processors 710 such as via the bus 702. The main memory 732, the static memory 734, and the storage unit 736 store the instructions 716 embodying any one or more of the methodologies or functions described herein. The instructions 716 may also reside, completely or partially, within the main memory 732, within the static memory 734, within the storage unit 736, within at least one of the processors 710 (e.g., within the processor's cache memory), or any suitable combination thereof, during execution thereof by the machine 700.

The I/O components 750 may comprise a wide variety of components to receive input, provide output, produce output, transmit information, exchange information, capture measurements, and so on. The specific I/O components 750 that are comprised in a particular machine will depend on the type of machine. For example, portable machines such as mobile phones will likely comprise a touch input device or other such input mechanisms, while a headless server machine will likely not comprise such a touch input device. It will be appreciated that the I/O components 750 may comprise many other components that are not shown in FIG. 7. The I/O components 750 are grouped according to functionality merely for simplifying the following discussion, and the grouping is in no way limiting. In various example embodiments, the I/O components 750 may comprise output components 752 and input components 754. The output components 752 may comprise visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may comprise alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 750 may comprise biometric components 756, motion components 758, environmental components 760, or position components 762, among a wide array of other components. For example, the biometric components 756 may comprise components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 758 may comprise acceleration sensor components (e.g., accelerometer), gravitation sensor components, rotation sensor components (e.g., gyroscope), and so forth. The environmental components 760 may comprise, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may comprise location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may comprise communication components 764 operable to couple the machine 700 to a network 780 or devices 770 via a coupling 782 and a coupling 772, respectively. For example, the communication components 764 may comprise a network interface component or another suitable device to interface with the network 780. In further examples, the communication components 764 may comprise wired communication components, wireless communication components, cellular communication components, near field communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., coupled via a USB).

Moreover, the communication components 764 may detect identifiers or comprise components operable to detect identifiers. For example, the communication components 764 may comprise radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

The various memories (e.g., 730, 732, 734, and/or memory of the processor(s) 710) and/or the storage unit 736 may store one or more sets of instructions 716 and data structures (e.g., software) embodying or utilized by any one or more of the methodologies or functions described herein. These instructions (e.g., the instructions 716), when executed by the processor(s) 710, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to comprise, but not be limited to, solid-state memories, and optical and magnetic media, comprising memory internal or external to processors. Specific examples of machine-storage media, computer-storage media, and/or device-storage media comprise non-volatile memory, comprising by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 780 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 780 or a portion of the network 780 may comprise a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) comprising 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 716 may be transmitted or received over the network 780 using a transmission medium via a network interface device (e.g., a network interface component comprised in the communication components 764) and utilizing any one of a number of well-known transfer protocols (e.g., HTTP). Similarly, the instructions 716 may be transmitted or received using a transmission medium via the coupling 772 (e.g., a peer-to-peer coupling) to the devices 770. The terms “transmission medium” and “signal medium” mean the same thing and may be used interchangeably in this disclosure. The terms “transmission medium” and “signal medium” shall be taken to comprise any intangible medium that is capable of storing, encoding, or carrying the instructions 716 for execution by the machine 700, and comprise digital or analog communication signals or other intangible media to facilitate communication of such software. Hence, the terms “transmission medium” and “signal medium” shall be taken to comprise any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to comprise both machine-storage media and transmission media. Thus, the terms comprise both storage devices/media and carrier waves/modulated data signals.

What is claimed is:

1. A system comprising:
at least one hardware processor;
a non-transitory computer-readable medium storing instructions that, when executed by the at least one hardware processor, cause the at least one hardware processor to perform operations comprising:
for each of a plurality of historical time series:
generating a prompt based on a natural language description pertaining to a corresponding historical time series;
sending the prompt to a large language model (LLM) to generate a semantic vector for the corresponding historical time series, each semantic vector being a sequence of numbers constituting an embedding of semantic meaning of natural language text in a N-dimensional space;
projecting the corresponding historical time series into one or more time series vectors, each time series vector existing in a different D-dimensional space;
combining, for each different D-dimensional space, the corresponding semantic vector and the corresponding time series vector into a combined vector;
clustering the combined vectors into a plurality of different clusters; and
predicting future data values in an input time series by matching a combined vector corresponding to the input time series to a center vector of one of the plurality of different clusters.

2. The system of claim 1, wherein the predicting comprises:
generating an input time series prompt based on a natural language description pertaining to the input time series;
sending the input time series prompt to the LLM to generate a semantic vector for the input time series;
projecting the input time series into an input time series vector in the D-dimensional space;
combing the semantic vector for the input time series with the input time series vector into a combined input time series vector; and
wherein the matching comprises matching the combined input time series vector to the center of the one of the plurality of different clusters.

3. The system of claim 1, wherein each D-dimensional space has a different semantic weight, the semantic weight being applied to the semantic vector prior to the combining.

4. The system of claim 1, wherein the clustering uses a K-means clustering algorithm.

5. The system of claim 1, wherein the clustering and the predicting use a suffix model.

6. The system of claim 4, wherein the K-means clustering algorithm is performed using Manhattan distance.

7. The system of claim 1, wherein each time series indicates demand of an item over time.

8. The system of claim 7, wherein the natural language description is a description of the item.

9. The system of claim 1, wherein the time series are stored in an in-memory database.

10. A method comprising:
for each of a plurality of historical time series:
generating a prompt based on a natural language description pertaining to a corresponding historical time series;
sending the prompt to a large language model (LLM) to generate a semantic vector for the corresponding historical time series, each semantic vector being a sequence of numbers constituting an embedding of semantic meaning of natural language text in a N-dimensional space;
projecting the corresponding historical time series into one or more time series vectors, each time series vector existing in a different D-dimensional space;
combining, for each different D-dimensional space, the corresponding semantic vector and the corresponding time series vector into a combined vector;
clustering the combined vectors into a plurality of different clusters; and
predicting future data values in an input time series by matching a combined vector corresponding to the input time series to a center vector of one of the plurality of different clusters.

11. The method of claim 10, wherein the projecting comprises:
generating an input time series prompt based on a natural language description pertaining to the input time series;
sending the input time series prompt to the LLM to generate a semantic vector for the input time series;
projecting the input time series into an input time series vector in the D-dimensional space;
combing the semantic vector for the input time series with the input time series vector into a combined input time series vector; and
wherein the matching comprises matching the combined input time series vector to the center of the one of the plurality of different clusters.

12. The method of claim 10, wherein the clustering uses a K-means clustering algorithm.

13. The method of claim 12, wherein the K-means clustering algorithm is performed using Manhattan distance.

14. The method of claim 10, wherein each time series indicates demand of an item over time.

15. The method of claim 14, wherein the natural language description is a description of the item.

16. The method of claim 10, wherein the time series are stored in an in-memory database.

17. A non-transitory machine-readable medium storing instructions which, when executed by one or more processors, cause the one or more processors to perform operations comprising:
for each of a plurality of historical time series:
generating a prompt based on a natural language description pertaining to a corresponding historical time series;
sending the prompt to a large language model (LLM) to generate a semantic vector for the corresponding historical time series, each semantic vector being a sequence of numbers constituting an embedding of semantic meaning of natural language text in a N-dimensional space;
projecting the corresponding historical time series into one or more time series vectors, each time series vector existing in a different D-dimensional space;
combining, for each different D-dimensional space, the corresponding semantic vector and the corresponding time series vector into a combined vector;
clustering the combined vectors into a plurality of different clusters; and
predicting future data values in an input time series by matching a combined vector corresponding to the input time series to a center vector of one of the plurality of different clusters.

18. The non-transitory machine-readable medium of claim 17, wherein the projecting comprises:
generating an input time series prompt based on a natural language description pertaining to the input time series;
sending the input time series prompt to the LLM to generate a semantic vector for the input time series;
projecting the input time series into an input time series vector in the D-dimensional space;
combing the semantic vector for the input time series with the input time series vector into a combined input time series vector; and
wherein the matching comprises matching the combined input time series vector to the center of the one of the plurality of different clusters.

19. The non-transitory machine-readable medium of claim 17, wherein each D-dimensional space has a different semantic weight, the semantic weight being applied to the semantic vector prior to the combining.

20. The non-transitory machine-readable medium of claim 17, wherein the clustering uses a K-means clustering algorithm.
